(19) United States
(12) Patent Application Publication
(10) Pub. No.: US 2012/0080422 A1
(43) Pub. Date: Apr. 5, 2012

(54) APPARATUS FOR MAKING HOT WATER USING CARBON HEATER

(76) Inventors: Kyu Sung CHUNG, Seoul (KR); Kwang Ho CHUNG, Seoul (KR)

(21) Appl. No.: 12/910,598

(22) Filed: Oct. 22, 2010

(30) Foreign Application Priority Data
Sep. 30, 2010 (KR) 10-2010-0095529

(51) Int. Cl. H05B 3/02

(52) U.S. Cl. 219/546

(57) ABSTRACT

An apparatus for making hot water using a carbon heater is provided, which includes a carbon hater disposed at the center, a heat transfer pipe assembly surrounding in contact with the outer circumference of the carbon heater and heated by the carbon heater to make hot water, and a heat proof member covering the outer side of the heat transfer pipe assembly to prevent transmission of the infrared ray produced from the carbon heater. It is possible to achieve hot water sterilized by the far-infrared ray generated from the carbon heater, have high performance of making hot water at a short time with the carbon heater, and minimize heat loss due to heat dissipation by improving thermal insulation performance by an external anti-heat dissipation member, by disposing a heat transfer pipe in close contact to the outer circumference of the carbon heater, and circulating water through the heat transfer pipe.

### CROSS-REFERENCE TO RELATED APPLICATION

This application claims the benefit under 35 U.S.C. §119(a) of Korean Patent Application No. 10-2010-0095529, filed on Sep. 30, 2010, the entire disclosure of which is incorporated herein by reference for all purposes.

### BACKGROUND OF THE INVENTION

1. Field of the Invention

The present invention relates to an apparatus for making hot water using a carbon heater, in detail an apparatus for making hot water using a carbon heater which can basically achieve hot water sterilized by the far-infrared ray generated from the carbon heater, has high performance of making hot water at a short time with the carbon heater, and minimize heat loss due to heat dissipation by improving thermal insulation performance by an external heat shielding member, by disposing a heat transfer pipe assembly in close contact to the outer circumference of the carbon heater, covering the outer circumference with the heat shielding member to prevent transmission of the infrared ray generated by the carbon heater, and then circulating water through the heat transfer pipe assembly to produce hot water.

2. Description of the Related Art

In general, a carbon (fiber) heater is a heater, in detail, a heater using a porous basalt fiber made by being immersed in colloide solution (solution made by mixing carbon nano powder with distilled water) and then centrifugal-dehydrated, vacuumized, and dried in a pressure tank such that a large amount of carbon nano particles are uniformly distributed and attached to the entire fiber tissue. For example, heating equipment, the heater can 1) perform partial heating at a low cost in comparison to other heating apparatuses (using oil and gas boilers) and reduce fuel cost by reducing the time for increasing temperature, 2) perform uniform heating over the entire area within the average temperature difference of 2° C. throughout the heating area, which is a defect of the electric Ondol panel and the film heater, 3) be directly installed without removing the existing floor (within 10 mm floor thickness after installing), 4) be directly used by insulating a damaged portion even if it is artificially damaged, that is, dipped or torn, without breaking, because it is fiber, and 5) be semi-permanently used because it is fiber, not a machine, without corroding or breaking, by complementing defects and removing inconvenience of the existing linear heater (electric Ondol panel) and surface heater (film heater).

The fiber heater can be used for various facilities other than heating equipment and hot water boilers.

Meanwhile, schematically describing apparatuses for making hot water of the related art, they include a housing having an internal surface and a common beater in the housing, such that they produce hot water by circulating water inside the housing to transfer heat with the heater.

### SUMMARY OF THE INVENTION

However, since the apparatuses for making hot water of the related art use a common heater, the thermal efficiency is low and it takes long time to heat water, such that energy is wasted. Further, the housing is not provided with a specific configuration for preventing heat dissipation, heat loss is large and thermal insulation performance is decreased, as a result, reliability of the apparatuses is deteriorated.

The present invention has been made to solve the problems and it is an object of the present invention to provide an apparatus for making hot water using a carbon heater which can basically achieve hot water sterilized by the far-infrared ray generated from the carbon heater, has high performance of making hot water at a short time with the carbon heater, and minimize heat loss due to heat dissipation by improving thermal insulation performance by an external heat shielding member, by disposing a heat transfer pipe assembly in close contact to the outer circumference of the carbon heater, covering the outer circumference with the heat shielding member to prevent transmission of the infrared ray generated by the carbon heater, and then circulating water through the heat transfer pipe assembly to produce hot water.

In order to accomplish the objects of the present invention, an apparatus for making hot water using a carbon heater includes: a carbon heater disposed at the center: a heat transfer pipe assembly surrounding in close contact the outer circumference of the carbon heater to be heated to make hot water by the carbon heater while water flows; and a heat shielding member covering the outer side of the heat transfer pipe assembly to prevent transmission of infrared rays produced from the carbon heater.

Further, in the apparatus for making hot water using a carbon heater according to the present invention, the carbon heater may include: a porous basalt fiber made by being immersed in colloide solution and then centrifugal-dehydrated, vacuumized, and dried in a pressure tank such that a large amount of carbon nano particles are uniformly distributed and attached to the entire fiber tissue; clamps electrically connected to both ends of the porous basalt fiber; conductive wires welded to ends of the clamps; a conductive plate welded to the conductive wires; a lead wire welded to the other end of the conductive plate; and a quartz pipe vacuumized inside with both ends melt and scaled to covered with both tense ends of the lead wire.

Further, in the apparatus for making hot water using a carbon heater according to the present invention, the heat transfer pipe assembly may continue over the entire outer circumference of the carbon heater in a zigzag shape from one end to the other end along the longitudinal direction of the carbon heater.

Further, in the apparatus for making hot water using a carbon heater according to the present invention, the heat transfer pipe assembly may be formed in a coil shape wound from an end to the other end in the longitudinal direction of the carbon heater.

Further, in the apparatus for making hot water using a carbon heater according to the present invention, the heat shielding member is made of reflective stainless steel.

As described above, the apparatus for making hot water using a carbon heater can basically achieve hot water sterilized by the far-infrared ray generated from the carbon heater, has high performance of making hot water at a short time with the carbon heater, and minimize heat loss due to heat dissipation by improving thermal insulation performance by an external anti-heat dissipation member, by disposing a heat transfer pipe in close contact to the outer circumference of the carbon heater, covering the outer circumference with the anti-heat dissipation member to prevent transmission of the infrared ray generated by the carbon heater, and then circulating water through the heat transfer pipe to produce hot water.

### BRIEF DESCRIPTION OF THE DRAWING

FIG. 1 is a perspective view of an apparatus for making hot water using a carbon heater according to an embodiment of the present invention.

FIG. 2 is an exploded perspective view of the apparatus for making hot water using a carbon heater according to an embodiment of the present invention.

FIG. 3 is a cross-sectional view of an apparatus for making hot water using a carbon heater according to another embodiment of the present invention.

FIG. 4 is a view schematically showing when a plurality of apparatuses for making hot water using a carbon heater is arranged in parallel, according to embodiments of the present invention.

### DETAILED DESCRIPTION OF THE PREFERRED EMBODIMENTS

The present invention having the configuration described above is described hereafter in detail with reference to the accompanying drawings.

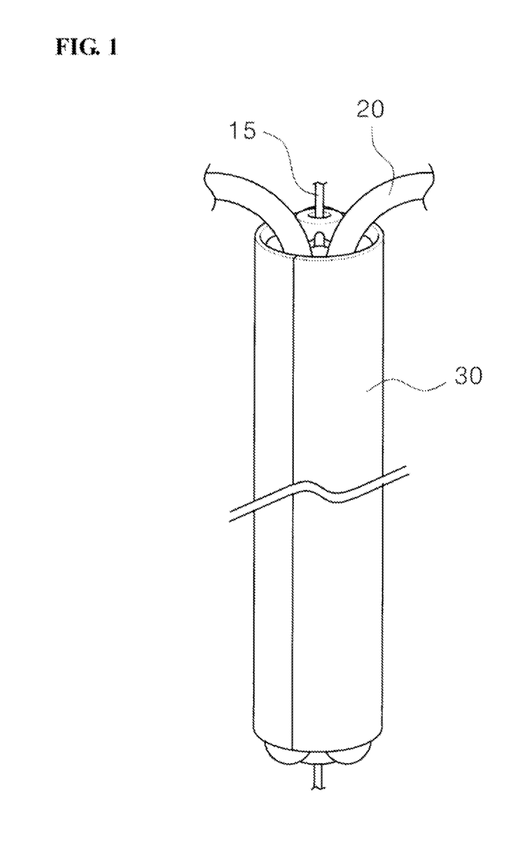

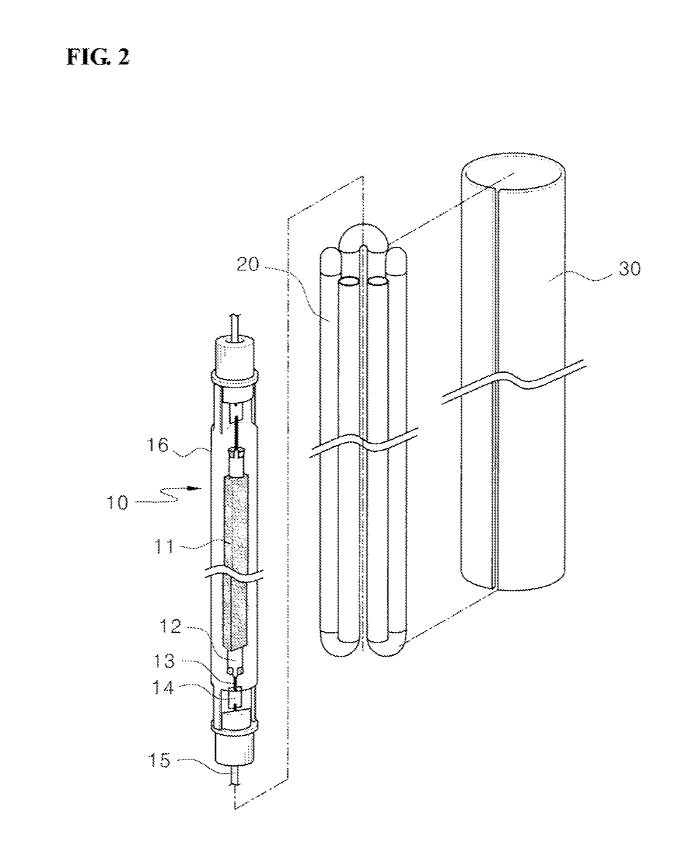

As shown in FIGS. 1 and 2, an apparatus for making hot water using a carbon heater according to an embodiment of the present invention includes a carbon hater 10 disposed at the center, a heat transfer pipe assembly 20 surrounding in close contact with the outer circumference of the carbon heater 10 and heated by the carbon heater 10 to make hot water, and a heat shielding member 30 covering the outer side of the heat transfer pipe assembly 20 to prevent transmission of the infrared ray produced from the carbon heater 10.

The carbon heater 10 includes a porous basalt fiber 11 made by being immersed in colloide solution and then centrifugal-dehydrated, vacuumized, and dried in a pressure tank such that a large amount of carbon nano particles are uniformly distributed and attached to the entire fiber tissue, clamps 12 electrically connected to both ends of the porous basalt fiber 11, conductive wires 13 welded to ends of the clamps 12, a conductive plate 14 welded to the conductive wires 13, a lead wire 15 welded to the other end of the conductive plate 14, and a quartz pipe 26 vacuumized inside with both ends melt and sealed to covered with both tense ends of the lead wire 15.

The heat transfer pipe assembly 20 continues over the entire outer circumference of the carbon heater 10 in a zigzag shape from one end to the other end along the longitudinal direction of the carbon heater 10.

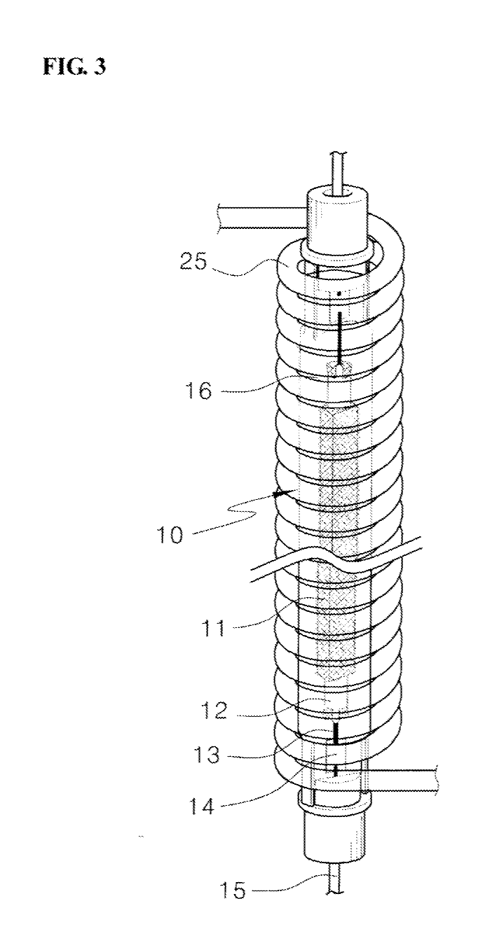

Alternatively, as shown in another embodiment of FIG. 3, the heat transfer pipe assembly 25 may be wound in a coil shape from an end to the other end along the longitudinal direction of the carbon heater 10.

The heat shielding member 30 is formed a thin metal plate to prevent transmission of the far-infrared ray produced from the carbon heater 10 and is preferably made of stainless steel for reflection.

Further, it may be formed a rectangular plate shape when being developed to cover the outer side of the heat transfer pipe assembly 20, or may be formed in a cylindrical shape in advance to attached to the outer side of the heat transfer assembly 20.

The apparatus for making hot water using a carbon heater according to an embodiment of the present invention is assembled as follows. First, the carbon heater 10 is positioned at the center and the heat transfer pipe assembly 20 is positioned in close contact to the outer circumference of the carbon heater in a zigzag shape of a coil shape.

In this structure, both end lead wires 25 of the carbon heater 20 are exposed to the outside of the heat transfer pipe assembly 20.

Next, the heat shielding member 30 is covered on the outer circumference of the heat transfer pipe body 20 to prevent transmission of the infrared ray, consequently, the apparatus for making hot water using a carbon heater according to the present invention is completed.

The complete apparatus for making hot water assembled described above makes and supplies hot water by operating the heater 10 to emit high-temperature heat and far-infrared rays, supplying cold water into the heat transfer pipe assembly 20 such that the water is heated by the carbon heater 10 disposed in close contact inside the heat transfer pipe assembly 20 and sent to places needing hot water.

Further, it is possible to make hot water with high thermal efficiency without heat loss by the heat shielding member 30.

Further, it is possible to achieve hot Water completely sterilized by the far-infrared rays from the carbon heater 10.

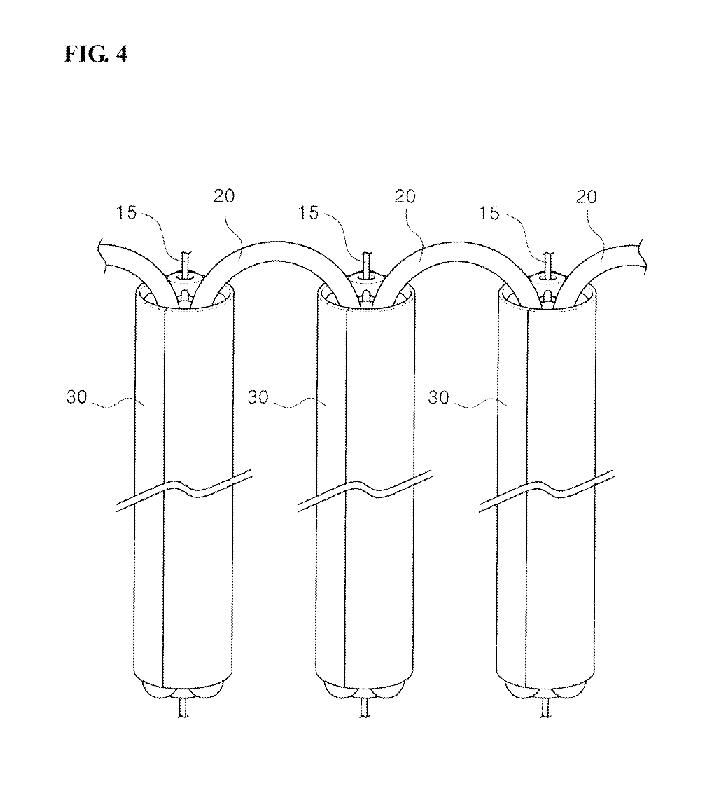

Meanwhile, the apparatus for making hot water can make hot water at low temperature in a single structure, or as shown in FIG. 4, it is possible to make hot water at high temperature by disposing a plurality of apparatuses for making hot water in parallel to continuously heat the water through the apparatuses for making hot water.

In the present invention, it can be expected to heat cold water at 18 of inflow temperature to 47° C. and make hot water of 4 liters of divided flow rate, by using three carbon heaters 10 of 5 kw electric power.

As described above, the present invention can basically achieve hot water sterilized by the far-infrared ray generated from the carbon heater 10, has high performance of making hot water at a short time with the carbon heater 10, and minimize heat loss due to heat dissipation by improving thermal insulation performance by the external heat shielding member 30, by disposing the heat transfer pipe assembly 20 in close contact to the outer circumference of the carbon heater 10. covering the outer circumference with the heat shielding member 30 to prevent transmission of the infrared ray generated by the carbon heater 10, and then circulating water through the heat transfer pipe assembly 20 to produce hot water.

As described above, although the present invention has been described by way of preferred embodiments, it should be understood that embodiments from simple combination with well-known configurations and others made by easily modifying the embodiments by those skilled in the related art are construed as being included in the scope of the present invention.

What is claimed is:

1. An apparatus for making hot water using a carbon heater, the apparatus comprising:
a carbon heater disposed at the center;
a heat transfer pipe assembly surrounding in close contact the outer circumference of the carbon heater to be heated to make hot water by the carbon heater while water flows; and
a heat shielding member covering the outer side of the heat transfer pipe assembly to prevent transmission of infrared rays produced from the carbon heater.

2. The apparatus according to claim 1, wherein the carbon heater includes:
a porous basalt fiber made by being immersed in colloide solution and then centrifugal-dehydrated, vacuumized, and dried in the pressure tank such that a large amount of carbon nano particles are uniformly distributed and attached to the entire fiber tissue:
clamps electrically connected to both ends of the porous basalt fiber:
conductive wires welded to ends of the clamps;
a conductive plate welded to the conductive wires;
a lead wire welded to the other end of the conductive plate; and
a quartz pipe vacuumized inside with both ends melt and sealed to covered with both tense ends of the lead wire.

3. The apparatus according to claim 1, wherein the heat transfer pipe assembly continues over the entire outer circumference of the carbon heater in a zigzag shape from one end to the other end along the longitudinal direction of the carbon heater.

4. The apparatus according to claim 1, wherein the heat transfer pipe assembly is formed in a coil shape wound from an end to the other end in the longitudinal direction of the carbon heater.

5. The apparatus according to claim 1, wherein the heat shielding member is made of reflective stainless steel.
